(19) United States
(12) Patent Application Publication
(10) Pub. No.: US 2025/0292068 A1
(43) Pub. Date: Sep. 18, 2025

(54) CONVERSION OF NEURAL NETWORKS BETWEEN DIFFERENT MEMORY LAYOUTS

(71) Applicant: Fireball Merger Sub II, LLC, San Diego, CA (US)

(72) Inventors: Bastiaan AARTS, San Jose, CA (US); Gustav LARSSON, San Francisco, CA (US); Wei DAI, Bellevue, WA (US)

(21) Appl. No.: 18/608,563

(22) Filed: Mar. 18, 2024

(51) Int. Cl. G06N 3/0464

(52) U.S. Cl. CPC G06N 3/0464

(57) ABSTRACT

Certain aspects of the present disclosure provide methods and apparatuses for machine learning model conversion. An example method generally includes receiving a request to execute operations using a source model including a plurality of source model tensors with a first memory layout. A plurality of target model tensors are generated, with each respective target model tensor being associated with a respective source model tensor. The source model is converted from a source architecture associated with the first memory layout to a target architecture associated with a second memory layout on a per-tensor basis based on a type of a machine learning model layer associated with each source model tensor. A model output is generated, and a converted model is generated based on the plurality of target model tensors and the generated model output. Operations are executed using the converted model.

### BACKGROUND

Aspects of the present disclosure generally relate to artificial intelligence and machine learning systems, and more specifically to techniques for converting between different memory layouts used by neural network frameworks.

Artificial neural networks (ANN), also referred to as deep neural networks (DNNs) provide an important tool for applying machine learning algorithms to solve various optimization problems for applications such as speech recognition, computer vision, medical image analysis, and natural language processing. Artificial neural networks work similarly to a human brain's neural network which includes a plurality of neurons organized in layers. Each neuron is an individual computational node that performs a mathematical function to determine an attribute output using one or more input datasets, such as images, audio data, videos, texts, speeches, etc. Typically, an artificial neural network includes a plurality of weights that represent connections between a layer and a layer beneath it. An artificial neural network may apply a backpropagation method to adjust a plurality of weights for different nodes in the artificial neural network in a computing system in order to perform a variety of computation tasks by finding a solution to minimize/maximize an objective function of an optimization problem in a defined domain.

In some cases, the nodes are organized into three types of layers: an input layer, one or more hidden layers, and an output layer. The input layer may be represented as a layer to process a tensor for initial input data for the artificial neural network. One or more hidden layers may include a convolutional layer, a pooling layer, a rectified linear unit (ReLU) layer, a softmax layer, a regressor layer, a dropout layer, and/or various other hidden layer types. Each of the one or more hidden layers may be represented as a layer in an intermediate layer between the input layer and the output layer to perform computation for various tasks on a tensor for intermediate results associated with the given inputs based on task-specific rules. The output layer processes a tensor for producing output data for the given inputs of the artificial neural network.

Artificial neural networks may implement a plurality of deep learning frameworks which may differ from each other. Artificial neural networks also may implement two different de-facto standard memory layouts for convolutional layers, such as a channel-first memory layout and a channel-last memory layout. These two different channel ordering formats are used to prepare and manipulate input data to meet formats for configuring one or more neural networks in different public or commercially offered deep learning libraries, such as TensorFlow, Keras, PyTorch, and ONNX.

In the channel-first memory layout, the channel dimension comes before the spatial dimensions, such as NCW, NCHW, and NCDHW for one-dimensional (1D), two-dimensional (2D), and three-dimensional (3D) convolutions, respectively, where N is the batch dimension, C is the number of input channels, such as color channels, and the remaining ones are the spatial dimensions (namely, width (W), height (H), and depth (D)). For example, image data is represented in a 3D tensor where the first channel represents color channels using the format [channels] [rows] [cols].

In the channel-last memory layout, the channel dimension comes after the spatial dimensions, such as NWC, NHWC, and NDHWC for the 1D, 2D, and 3D convolutions, respectively. For example, image data is represented in a 3D tensor where the last channel represents the color channels using the format [rows] [cols] [channels].

Virtually all deep learning frameworks, neural network formats, and lower-level deep learning software have adopted one or both of these formats. Most of these frameworks, formats, and software support one memory layout, and when both memory layouts are supported, one is typically preferred for use in performing machine learning operations (e.g., training and/or inferencing). For example, the execution of a model trained using the PyTorch framework involves a channel-first memory layout. As another example, the execution of a TensorFlow (TF)-Lite model trained using the TensorFlow framework for mobile and edge applications involves a channel-last memory layout. However, because these two frameworks use different memory layouts for convolutional layers, the neural network is typically converted from one deep learning framework to another (e.g., during code generation, compilation etc.). When converting a neural network from one framework to the other, layout conversions using additional transposes are performed to create a semantically correct model that, when executed, performs the same as the original model. The additional transposes add to the overall latency of model execution and thus degrades model performance (e.g., in terms of an amount of time elapsed in training a model, a number of inferences generated by a trained model over a defined time period, etc.).

### BRIEF SUMMARY

Certain aspects of the present disclosure provide methods and apparatuses for machine learning model conversion. An example method generally includes receiving a request to execute operations using a source model including a plurality of source model tensors with a first memory layout. A plurality of target model tensors are generated, with each respective target model tensor being associated with a respective source model tensor. The source model is converted from a source architecture associated with the first memory layout to a target architecture associated with a second memory layout on a per-tensor basis based on a type of a machine learning model layer associated with each source model tensor. A model output is generated, and a converted model is generated based on the plurality of target model tensors and the generated model output. Operations are executed using the converted model.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain features of various aspects of the present disclosure and are therefore not to be considered limiting of the scope of this disclosure.

FIG. 1A and FIG. 1B illustrate a distributed computer system for converting a neural network from a source model framework to a target model framework, according to aspects of the present disclosure.

FIG. 2 illustrates infrastructure of a deep learning neural network, according to aspects of the present disclosure.

FIG. 3 illustrates an example channel-first memory layout and channel-last memory layout of a model tensor, according to aspects of the present disclosure.

FIG. 4A illustrates an example process for determining initialized maps for a source memory layout and source tensors to a target memory layout and target tensors in the source memory layout, according to aspects of the present disclosure.

FIG. 4B illustrates an example process for converting a plurality of model layers of an input neural network from a source memory layout to a target memory layout, according to aspects of the present disclosure.

FIG. 4C illustrates an example process for determining an output model tensor in a target memory layout, according to aspects of the present disclosure.

FIG. 5 illustrates example operations for converting a neural network from a source model framework associated with a first memory layout to a target model framework associated with a second memory layout, according to aspects of the present disclosure.

FIG. 6 illustrates an example computer system on which aspects of the present disclosure may be performed.

### DETAILED DESCRIPTION

According to various aspects, computer-implemented methods and systems provide an efficient code generator to convert neural networks between two different memory layouts, such as a channel-first memory layout and a channel-last memory layout. In some aspects, a distributed computer system is programmed to minimize (or at least reduce) the number of additional transposes involved in performing conversions of the neural networks from one deep learning framework to another deep learning framework. Different neural networks may support one or both of these two memory formats. The choice of the memory format can affect the performance of the neural network and the deep learning libraries. Therefore, converting neural networks from one format to another can improve the computation power of the neural networks.

To convert a machine learning model or other neural network from a first framework (with a first memory/tensor layout) to a second framework (with a second memory/tensor layout), a converter may be used to perform these transformations via an intermediate model representation. For example, to convert from a channel-first memory layout to a channel-last memory layout, a neural network may be converted from a PyTorch framework to an ONNX framework to a TensorFlow framework, since the PyTorch framework and the ONNX framework adhere to the channel-first memory layout, while the TensorFlow framework adheres to the channel-last memory layout. These converters usually convert between formats just before and after computational operations that require a format conversion. For example, for a convolution layer, the neural network may be converted from an input memory layout, such as a channel-first memory layout, to a target memory layout, such as a channel-last memory layout, just prior to the execution of the convolution layer. Likewise, the neural network may be converted back to the input memory layout, such as the channel-first memory layout, just after the execution of the convolution layer. As a result, conversion between different memory layouts is usually computationally expensive because many superfluous transposes are applied in conversion between different memory layouts, wasting processor time, memory, and other computational resources.

To improve resource utilization involved in converting between different memory layouts used by different neural networks or neural network frameworks, aspects of the present disclosure provide techniques for converting a neural network from a first memory layout to a second memory layout while minimizing (or at least reducing) additional transposes to generate target tensors using input source tensors for a plurality of model layers of the neural network during conversion. The neural network may generally be converted using a source model graph in a topological traversal to ensure that all the model layer inputs are previously converted to proper memory layouts when converting a model layer from the first memory layout to the second memory layout. Any target tensor may include both an original and a transposed memory layout at the same time during the source model topological traversal.

Aspects of the present disclosure may track a plurality of memory layouts based on layer input classifications associated with the generated target tensors by maintaining maps from the input source tensors to the target tensors. The layer input classifications are assigned based on how the layer inputs are processed. For example, a reshape layer has an input layer classification “1” as the model layer operates on channel-first inputs. As another example, a convolution layer has an input layer classification “2” as the model layer operates on channel-last inputs. Based on different input layer classifications, the present approach may record target tensors that are available in the transposed layout. In particular, aspects of the present disclosure do not generate target tensors in the original memory layout after converting a model layer with an input layer classification “2” to effectively postpone the insertion of an additional transpose layer until it is required. As a result, the present approach may efficiently minimize (or at least reduce) the number of additional transposes by determining the layer input classifications to determine how the layer inputs are processed, which may allow for more efficient use of computational resources and allow for more efficient and faster execution of machine learning model operations.

### Example Distributed Computing System for Converting a Neural Network From a Source Model Framework to a Target Model Framework

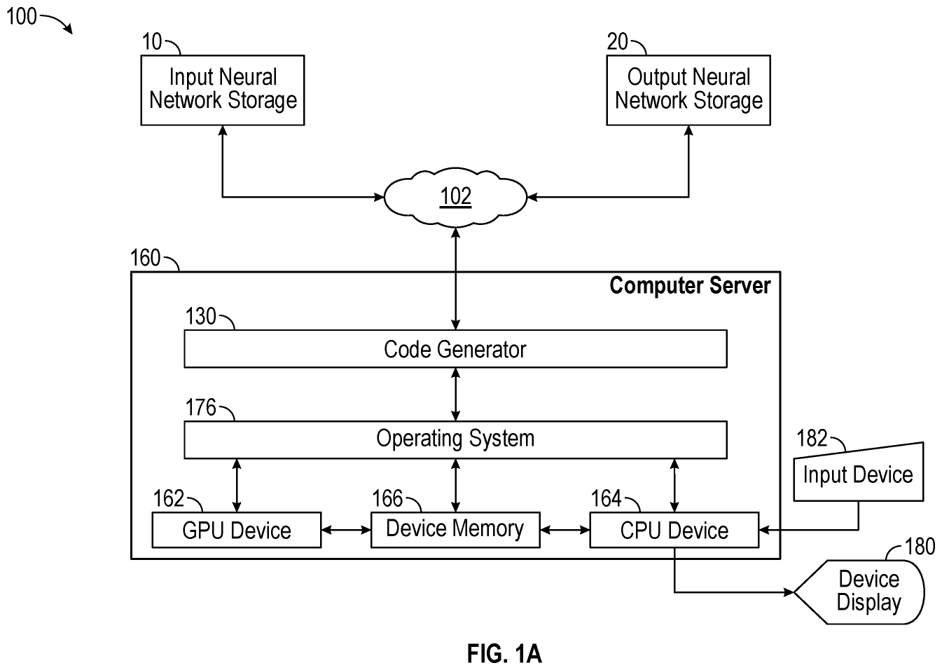

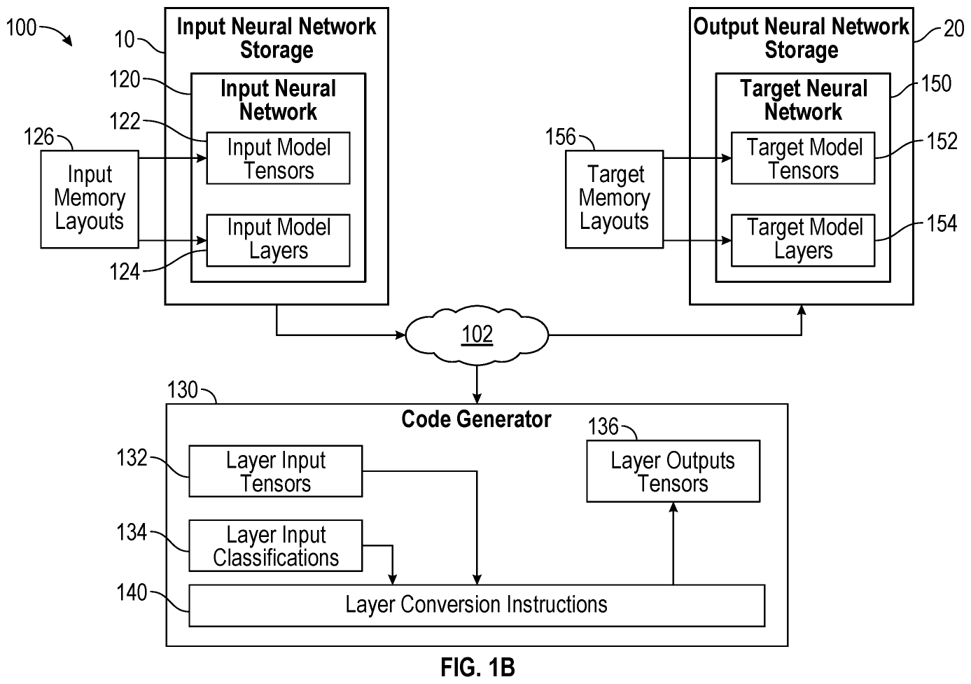

FIG. 1A and FIG. 1B illustrate a distributed computer system 100 for converting a neural network from a source model framework to a target model framework in accordance with aspects of the present disclosure. In an aspect, the distributed computer system 100 comprises components implemented partially by hardware at one or more computing devices, such as one or more hardware processors executing stored program instructions stored in one or more memories for performing the functions described herein. In other words, all functions described herein are intended to indicate operations performed using programming in a special or general-purpose computer in various aspects. FIG. 1A and FIG. 1B illustrate only one of many possible arrangements of components configured to execute the programming described herein. Other arrangements may include fewer or different components, and the division of work between the components may vary depending on the arrangement.

FIG. 1A and FIG. 1B, and the other drawing figures and all of the description and claims in this disclosure, are intended to present, disclose, and claim a technical system and technical methods in which specially programmed computers, using a special-purpose distributed computer system design, execute functions that have not been available before to provide a practical application of computing technology to the problem of converting a neural network from one deep learning framework using a first memory layout, such as a channel-first memory layout, to another deep learning framework using a second memory layout, such as a channel-last memory layout. In this manner, the disclosure presents a technical solution to a technical problem, and any interpretation of the disclosure or claims to cover any judicial exception to patent eligibility, such as an abstract idea, mental process, method of organizing human activity, or mathematical algorithm, has no support in this disclosure and is erroneous.

In some aspects, the distributed computer system 100 may include an input neural network storage 10 and an output neural network storage 20 that are communicatively coupled via a network 102 to a computer server 160. In one aspect, each of the input neural network storage 10 and the output neural network storage 20 comprise one or more virtual storage instances of a virtual computing environment or cloud computing service. In other aspects, the input neural network storage 10 and the output neural network storage 20 comprise local storage devices or network attached storage that are communicatively coupled via a local area network to a computer server 160.

The computer server 160 is communicatively coupled to the input neural network storage 10 and the output neural network storage 20 over a network 102. The network 102 broadly represents any combination of one or more data communication networks including local area networks, wide area networks, internetworks, or internets, using wireline or wireless links, including terrestrial or satellite links. The network(s) may be implemented by any medium or mechanism that provides for the exchange of data between the various elements of FIG. 1A and FIG. 1B. The various elements of FIG. 1A and FIG. 1B may also have direct (wired or wireless) communication links. The input neural network storage 10, the output neural network storage 20, the computer server 160, and other elements of the system may each comprise an interface compatible with the network 102 and may be programmed or configured to use standardized protocols for communication across the networks such as TCP/IP, Bluetooth, or higher-layer protocols such as HTTPS (HTTP with Transport Layer Security (TLS)), and the like.

The computer server 160 may be implemented, in various aspects, using one or more virtual compute instances of a virtual computing environment or cloud computing service, or one or more server computers, desktop computers, laptop computers, or workstations.

The computer server 160 further comprises at least one graphics processing unit (GPU) device 162 and at least one central processing unit (CPU) device that are communicatively coupled to a device memory 166. The GPU devices 162 and/or CPU devices 164 host or execute an operating system 176. In one aspect, the computer server 160 may host and execute one or more application programs, which the computer server 160 may download and install from an input device 182, an application store, or another repository. For example, the computer server 160 may download the one or more application programs from a remote application repository to different client computing devices. In aspects, the computer server 160 may provide an application extension for an application program through which the aforementioned communication and other functionality may be implemented. In particular, the application extension may include one or more machine learning libraries, such as TensorFlow, Keras, PyTorch, ONNX, etc.

In some aspects, a device display 180, such as a screen, may be coupled to the GPU devices 162 and/or the CPU devices 164, or to an input/output (I/O) subsystem or display driver (not illustrated) that the devices can address. The GPU devices 162 may be configured to perform complex mathematical calculations for parallel processing. Thus, the GPU devices 162 may process identical, simultaneous operations for machine learning with massive parallel inputs of largely identical or unstructured data. The CPU devices 164 may be configured to perform complex mathematical calculations quickly by processing one problem at a time. In particular, the CPU devices 164 may process algorithm-intensive machine learning tasks that do not require parallel processing, such as sequential algorithms for inference and recommender with high memory requirements for embedding layers.

Referring now to FIG. 1B, in one aspect, the distributed computer system 100 is configured to use the code generator 130 to convert, in real time, just-in-time (JIT), or “on the fly,” an input neural network 120 (also referred to herein as a source neural network) with an input memory layout 126, such as a channel-first memory layout, to a target neural network 150, with a target memory layout 156, such as a channel-last memory layout. The input memory layouts 126 and the target memory layouts 156 refer to the physical or structural organization, formatting, ordering, or arrangement of byte values in digital electronic computer memory, such as DRAM, NVRAM, or memory of virtual compute instances, in which the tensors and layers of the input neural network 120 and the target neural network 150 are digitally stored.

In some aspects, the computer server 160 may be programmed to access input data from one or more machine learning libraries in the input neural network storage 10 and the output neural network storage 20, such as images, audio, video, text, or speech. For example, the computer server 160 may be programmed to access one or more neural networks in the input neural network storage 10, such as the input neural network 120. The input neural network 120 may include one or more input model tensors 122 and one or more input model layers 124. The input neural network may be, for example, a convolutional neural network (CNN), long short-term memory network (LSTM), recurrent neural network (RNN), generative adversarial network (GAN), multilayer perceptrons network (MLP), Wave LM network, MobileNet++, U-net, or other neural networks. In some aspects, each of the one or more input model tensors 122 and the one or more input model layers 124 includes an input memory layout 126, such as a channel-first memory layout. As another example, the computer server 160 may be programmed to access one or more target neural networks in the output neural network storage 20, such as the target neural network 150. The target neural network 150 may include one or more target model tensors 152 and one or more target model layers 154. The target neural network 150 may be, for example, a convolutional neural network (CNN), long short-term memory network (LSTM), recurrent neural network (RNN), generative adversarial network (GAN), multilayer perceptrons network (MLP), Wave LM networks, MobileNet++, U-net. or other neural networks. In some aspects, each of the one or more target model tensors 152 and the one or more target model layers 154 includes the target memory layout 156, such as a channel-last memory layout.

In some aspects, the computer server 160 may be programmed to implement a code generator 130 to convert one or more neural networks using the input neural network storage 10 and the output neural network storage 20 for various applications, such as audio classification, acoustic echo cancellation, video background segmentation, text-to-speech, object detection, imaging filtering, security tracking, content generation, etc. For example, the computer server 160 may be programmed to communicate with the code generator 130 by using layer conversion instructions 140 to convert a neural network between different frameworks, such as a channel-first memory layout and a channel-last memory layout. As another example, the computer server 160 may be programmed to store the outcome, such as the target neural network 150, in the output neural network storage 20. Thus, the input device 182 may execute the target neural network 150 for a desired deep learning framework, such as a PyTorch model on Android, or a TensorFlow model for mobile and edge applications.

In some aspects, the input neural network 120 includes a plurality of model layers, such as the input model layers 124. For each model layer, the input neural network 120 includes a model tensor, such as the input model tensors 122, having a first memory layout, such as the input memory layouts 126. The input neural network 120 may be generated for execution of a PyTorch model on Android or an intermediate model, such as an ONNX model, which adheres to a channel-first memory layout. In one example, at each input model layer 124 in which the input model layer 124 is a convolutional layer, the input model tensor 122 may be a convolutional kernel including an activation input and a kernel (or weight, or parameter) input. The convolutional kernel may have a kernel size of (Cₒᵤₜ, Cᵢₙ, H, W) which has a 4D input array with an input size (N, Cᵢₙ, Hᵢₙ, Wᵢₙ) and a 4D output array with an output size (N, Cₒᵤₜ, Hₒᵤₜ, Wₒᵤₜ). N is a batch dimension, Cᵢₙ is a number of input model tensor channels, Cᵢₙ is a number of input channels, and Cₒᵤₜ is a number of output channels. Hₖ, and Wₖ are height and width of the convolutional kernel, respectively. Hᵢₙ and Wᵢₙ are height and width of the 2D input array, respectively. Hₒᵤₜ and Wₒᵤₜ are the height and width of the 2D output array, respectively. For example, when the input model tensor 122 is a convolutional kernel having a size of (2, 2, 3, 3) and the input array has an input size of (1, 2, 6, 6), the output array has an output size of (1, 2, 4, 4) for a valid padding array p of (0, 0) and a stride array s of (1, 1) based on equations 1 and 2. The kernel size (Cₒᵤₜ, Cᵢₙ, H, W) characterizes a field of view, such as Hₖ×Wₖ pixels, for the convolution on the 2D input array for each channel. The stride array s characterizes a step size along the height or width direction for applying the convolutional kernel to the 2D input array. The padding array p characterizes the padding length along the height or width direction of the 2D input array for each channel.

$${H}_{out} = ⌊ \frac{{H}_{i n} + 2 \times p [ 0 ] - {H}_{k}}{s [ 0 ]} ⌋ + 1 \qquad ( Equation 1 )$$

$${W}_{out} = ⌊ \frac{{W}_{i n} + 2 \times p [ 1 ] - {W}_{k}}{s [ 1 ]} ⌋ + 1 \qquad ( Equation 2 )$$

wherein Hₖ, and Wₖ are the height and width of the convolutional kernel, respectively. Hᵢₙ and Wᵢₙ are the height and width of the 2D input array, respectively. Hₒᵤₜ and Wₒᵤₜ are the height and width of the 2D output array, respectively. p [0] is the padding length along the height direction. P[1] is the padding length along the width direction. S[0] is the stride step size along the height direction. S[1] is the stride step size along the width direction.

In some aspects, the input neural network 120 may be generated for execution of a TensorFlow model for mobile and edge applications, which adheres to a channel-last memory layout. At each input model layer 124, the input model tensor 122 is a convolutional kernel with a kernel size of (Hₖ, Wₖ, Cᵢₙ, Cₒᵤₜ) which has a 2D input array with an input size (N, Hᵢₙ, Wᵢₙ, Cᵢₙ) and a 2D output array with an output size (N, Hₒᵤₜ, Wₒᵤₜ, Cₒᵤₜ). N is batch dimension, Cₖ is number of input model tensor channels, Cᵢₙ is number of input channels, and Cₒᵤₜ is number of output channels. Hₖ, and Wₖ are height and width of the convolutional kernel, respectively. Hᵢₙ and Wᵢₙ are height and width of the 2D input array, respectively. Hₒᵤₜ and Wₒᵤₜ are height and width of the 2D output array, respectively. For example, when the input model tensor 122 is a convolutional kernel having a size of (3, 3, 2, 2) and the input array has an input size of (1, 6, 6, 2), it may determine that the output array has an output size of (1, 4, 4, 2) for a valid padding array p of (0, 0) and a stride array s of (1, 1) based on equations 1 and 2. The kernel size (Hₖ, Wₖ, Cᵢₙ, Cₒᵤₜ) characterizes a field of view, such as Hₖ×Wₖ pixels, for the convolution on the 2D input array for each channel. The stride array s characterizes a step size along the height or width direction for applying the convolutional kernel to the 2D input array. The padding array p characterizes the padding length along the height or width direction of the 2D input array for each channel.

In some aspects, the channel ordering format for the input memory layouts 126 of the input neural network 120 may be determined for performance-tuning reasons to configure different image processing and deep learning libraries, such as TensorFlow, Keras, PyTorch, Open Neural Network Exchange (ONNX), or the like. The code generator 130 is configured to convert the input neural network 120 between two different channel formats, such as a channel-first memory layout and a channel-last memory layout. In particular, the code generator 130 is programmed to implement a plurality of the layer conversion instructions 140 to traverse a model graph of the input neural network 120 in a topological (reverse post-order) traversal for different machine learning operations, such as reshape, convolution, resize, grid_sample, elementwise, and reduction layers, etc. For example, the code generator 130 is implemented to convert a convolutional model layer, such as the layer input tensors 132, determined based on a corresponding input model layer 124 having an input memory layout 126 associated with the input neural network 120 to a convolutional model layer, such as layer output tensors 136, determined for a corresponding target model layer 154 having a target memory layout 156 associated with the target neural network 150. As another example, when the code generator 130 converts a current model layer between channel formats, the code generator 130 would have properly converted all the layer inputs to the current model layer. The layer inputs may be used for conditional execution operations of the model layer, such as ifs and loops.

In some aspects, the target neural network 150 includes a plurality of model layers, such as the target model layers 154. For each model layer, the target neural network 150 includes a model tensor, such as the target model tensors 152, having a second memory layout, such as the target memory layouts 156. The target neural network 150 may be generated for execution of a PyTorch model on Android or an intermediate model, such as an ONNX model, which adheres to a channel-first memory layout. At each target model layer 154, the target model tensor 152 is a convolutional kernel with a kernel size (Cₒᵤₜ, Cᵢₙ, H, W) which has a 2D input array with an input size (N, Cᵢₙ, Hᵢₙ , Wᵢₙ) and a 2D output array with an output size (N, Cₒᵤₜ, Hₒᵤₜ, Wₒᵤₜ). N is a batch dimension, Cₖ is a number of target model tensor channels, Cᵢₙ is a number of input channels, and Cₒᵤₜ is a number of output channels. Hₖ, and Wₖ are height and width of the convolutional kernel, respectively. Hᵢₙ and Wᵢₙ are height and width of the 2D input array, respectively. Hₒᵤₜ and Wₒᵤₜ are the height and width of the 2D output array, respectively. For example, when the target model tensor 152 is a convolutional kernel having a size of (2, 2, 3, 3) and the input array has an input size of (1, 2, 6, 6), it may determine that the output array has an output size of (1, 2, 4, 4) for a valid padding array p of (0, 0) and a stride array s of (1, 1) based on equations 1 and 2. The kernel size (Cₒᵤₜ, Cᵢₙ, H, W) characterizes a field of view, such as Hₖ×Wₖ pixels, for the convolution on the 2D input array for each channel. The stride array s characterizes a step size along the height or width direction for applying the convolutional kernel to the 2D input array. The padding array p characterizes the padding length along the height or width direction of the 2D input array for each channel.

In some aspects, the target neural network 150 may be generated for execution of a TensorFlow model for mobile and edge applications, which adheres to a channel-last memory layout. At each the target model layer 154, the target model tensor 152 is a convolutional kernel with a kernel size (Cₒᵤₜ, Cᵢₙ, H, W) which has a 2D input array with an input size (N, Hᵢₙ, Wᵢₙ, Cᵢₙ) and a 2D output array with an output size (N, Hₒᵤₜ, Wₒᵤₜ, Cₒᵤₜ). N is batch dimension, Cₖ is a number of target model tensor channels, Cᵢₙ is a number of input channels, and Cₒᵤₜ is a number of output channels. Hₖ, and Wₖ are height and width of the convolutional kernel, respectively. Hᵢₙ and Wᵢₙ are height and width of the 2D input array, respectively. Hₒᵤₜ and Wₒᵤₜ are height and width of the 2D output array, respectively. For example, when the target model tensor 152 is a convolutional kernel having a size of (3, 3, 2, 2) and the input array has an input size of (1, 6, 6, 2), it may determine that the output array has an output size of (1, 4, 4, 2) for a valid padding array p of (0, 0) and a stride array s of (1, 1) based on equations 1 and 2. The kernel size (Cₒᵤₜ, Cᵢₙ, H, W) characterizes a field of view, such as Hₖ×Wₖ pixels, for the convolution on the 2D input array for each channel. The stride array s characterizes a step size along the height or width direction for applying the convolutional kernel to the 2D input array. The padding array p characterizes the padding length along the height or width direction of the 2D input array for each channel.

In some aspects, the code generator 130 is configured to keep track of the memory layout of the generated target model tensors 152 by maintaining maps from the input model tensors 122 to the target model tensors 152. The maps may be temporarily stored in memory or permanently stored as the input memory layouts 126 and the target memory layouts 156 in the input neural network storage 10 and/or the output neural network storage 20 as appropriate. In particular, for each layer input tensor 132 obtained from the input model tensors 122, the code generator 130 is programmed to determine a first previously generated target model tensor original_layout_tensor[t] (if any such previously generated target model tensor is present in the input neural network storage 10), which is in the same memory layout as the corresponding layer input tensor. Likewise, for each layer input tensor 132 obtained from the input model tensors 122, the code generator 130 is programmed to determine a second previously generated target model tensor transposed_layout_tensor[t] (if any such previously generated target model tensor is present in the input neural network storage 10), which is in the transposed memory layout as the corresponding layer input tensor. For example, for a layer input tensor t=2 having a channel-first memory layout which is associated with the second layer input tensor in the input model tensors 122, the first previously generated target model tensor original_layout_tensor[2] has a channel-first memory layout and the second previously generated target model tensor transposed_layout_tensor[2] has a channel-last memory layout. Therefore, for any model layer of input model layers 124, code generator 130 may determine the previously generated target tensors in both the channel-first memory layout and the channel-last memory layout, which are stored in memory for an on-the-fly code generator 130 that converts the input neural network 120 to the target neural network 150.

In some aspects, the code generator 130 is configured to convert an input model layer 124 to a target model layer 154 one layer at a time in order to minimize (or at least reduce) the number of additional transposes. The code generator 130 is programmed to determine a layer input classification 134 for each of the plurality of model layers, such as the input model layers 124, associated with the input model tensor 122. In particular, the code generator 130 determines a plurality of layer input classifications 134 to determine how one or more model layer inputs would be processed based on one or more requirements and preferences of a corresponding model layer.

In some aspects, the layer input classifications 134 may include four different types of model layers. For example, a layer input classification “1” is assigned to a model layer, such as a reshape layer, which may operate on a model layer input in a channel-first memory layout. Therefore, transposes are not composable with reshape-style layers, and input/target model tensors may generally be in their original layouts before executing an operation in the first model layer. As another example, a layer input classification “2” is assigned to a model layer, such as a convolution layer, a resize layer, or a grid_sample layer, etc., which may operate on a model layer input in a channel-last memory layout. In particular, when the target neural network 150 in a deep learning library, such as TensorFlow or TensorFlow Lite, the image input layer may be in a channel-last memory layout for an operation, such as convolution, resize, grid_sample, etc., because a channel-first memory layout is not supported by the deep learning library. As another example, a layer input classification “3” is assigned to a model layer, such as an unary element-wise and reduction layer, which may operate on a model layer input either in a channel-first memory layout or a channel-last memory layout. Thus, the code generator 130 may execute these model layers and operate on either memory layout without additional transposes. As another example, a layer input classification “4” is assigned to a model layer, such as a binary clement-wise layer, which may operate on a plurality of model layer inputs in the same layout. An example of converting an input neural network between channel formats for different machine learning operations can be found in Table 1 below.

In some aspects, based on the layer input classifications 134 and machine learning operations for the input model layers 124, the code generator 130 may merely record that the target model tensors 152 of such a layer which is only available in the transposed memory layout. The code generator 130 may use the plurality of layer input classifications 134 to effectively postpone the insertion of an additional transpose model layer until the moment it is required, which often results in transposes that are not needed. For example, the code generator 130 may not convert the target model tensors 152 back to an original layout, such as a channel-first memory layout, after converting model layers with a layer input classification “2” for the input neural network 120. The code generator 130 need not go back to change a memory layout generated previously. As another example, the code generator 130 may avoid any transposes if no model layer with a layer input classification “2” is present in the input neural network. As a result, the code generator 130 may efficiently convert the input neural network by minimizing the number of conversions between channel-first and channel-last convolution memory layouts for neural networks. In particular, the code generator 130 may be applied to a plurality of applications that span image, video, audio, and speech applications with significant performance improvements depending on the use case. For example, the code generator 130 may be applied for video background segmentation for identifying foreground vs background in video applications, text-to-speech for converting text to a stream of human synthesized speech based on a 1D convolutional neural network, acoustic echo cancellation for cancelling of echoes, reverberations, and other unwanted sounds in an audio stream, and image filtering for filtrating an image to obtain a “stylized” version of the same image, and object detection for identifying bounding boxes given an image. In each of these applications, amongst others, the techniques described herein may accelerate model execution relative to techniques that perform transposes that may not be needed in order to execute a machine learning model using a target memory architecture different from a source memory architecture.

In some aspects, the code generator 130 is configured to determine additional transposes to convert the input neural network 120 to a target neural network 150. The additional transposes are determined without assuming all inputs are pre-transposed tensors for rank 3, 4, and 5, such as channel, height, and weight. Various model conversion techniques, such as onnx2tf, may solve a massive transpose extrapolation problem in order to change the memory layouts of the inputs and outputs of an input neural network by requiring a user to pre-transpose the inputs of the input neural network and post-transpose the outputs of the input neural network to make the conversion produce a drop-in equivalent target neural network. However, the code generator 130 may convert the input neural network between different channel formats to generate a target neural network with an identical interface with improved input flexibility. As a result, the code generator 130 may improve efficiency of converting a neural network by solving the massive transpose extrapolation problem with time complexity is O(number of inputs to the input neural network)+O(number of layers in the input neural network)+O(number of output from the input neural network) which in practice is O (number of layers in the input neural network), as the number of inputs and outputs are typically an order of magnitude smaller than the number of layers in the input neural network.

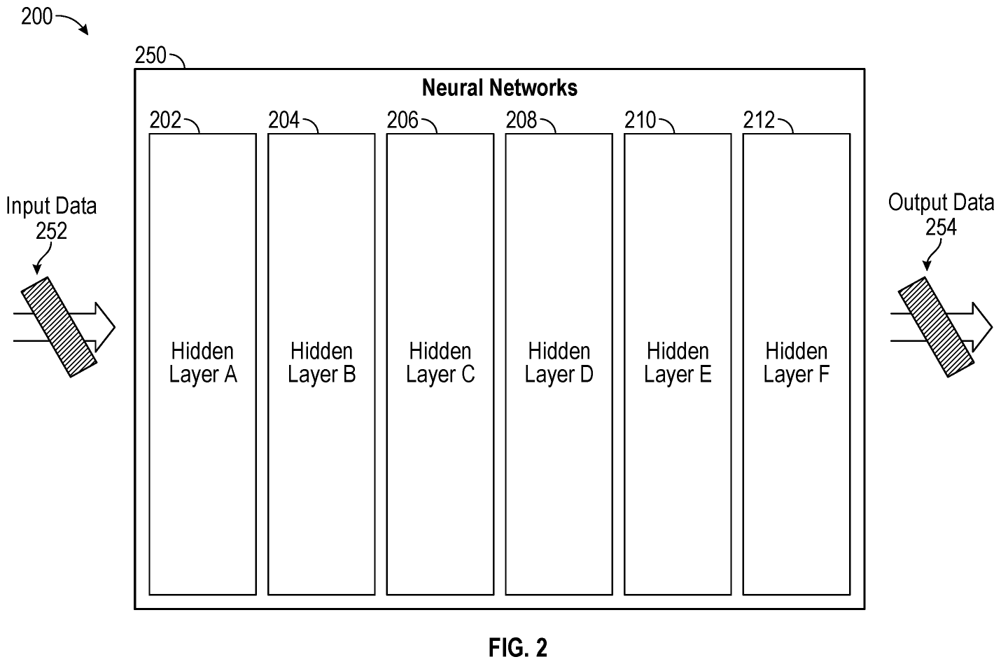

FIG. 2 illustrates the infrastructure 200 of a deep learning neural network 250 in accordance with aspects of the present disclosure. In particular aspects, the deep learning neural network 250 may be implemented for determining output data 254 using input data 252 based on a deep learning library. The deep learning neural network 250 may include one or more deep learning neural networks, such as CNNs, LSTMs, RNNs, GANs, MLPs, Wave LM networks, MobileNet++, U-net, etc., for applications in video background segmentation, text-to-speech, acoustic echo cancellation, imaging filtering, and object detection. The deep learning neural network 250 may include six hidden layers, such as a hidden layer A 202, a hidden layer B 204, a hidden layer C 206, a hidden layer D 208, a hidden layer E 210, a hidden layer F 212, which may be a convolutional layer, a pooling layer, a rectified linear unit (ReLU) layer, a softmax layer, a regressor layer, a dropout layer, and/or various other hidden layer types. In particular aspects, the number of hidden layers may be greater than or less than six. These hidden layers can be arranged in any order as long as they satisfy the input/output size criteria. Each layer comprises a set number of image filters. The output of filters from each layer is stacked together in the third dimension. This filter response stack then serves as the input to the next layer(s).

In particular aspects, the hidden layers are configured as follows. The hidden layer A 202 and the hidden layer B 204 may be down-sampling blocks to extract high-level features from the input data set. The hidden layer D 208 and the hidden layer E 210 may be up-sampling blocks to output the classified or predicted output data set. The hidden layer C 206 may perform residual stacking as bottleneck between down-sampling blocks (e.g., the hidden layer A 202, the hidden layer B 204) and up-sampling blocks (e.g., the hidden layer D 208, the hidden layer E 210). The hidden layer F 212 may include a softmax layer or a regressor layer to classify or predict a predetermined class or a value based on input attributes.

In a convolutional layer, the input data set is convolved with a set of learned filters that are designed to highlight specific characteristics of the input data set. A pooling layer produces a scaled down version of the output by considering small neighborhood regions and applying a desired operation filter (e.g. min, max, mean, etc.) across the neighborhood. A ReLU layer enhances a nonlinear property of the network by introducing a non-saturating activation function. One example of such a non-saturating function is to threshold out negative responses (i.e., set negative values to zero). A fully connected layer provides a high-level reasoning by connecting each node in the layer to all activation nodes in the previous layer. A softmax layer maps the inputs from the previous layer into a value between 0 and 1 or between −1 and 1. Therefore, a softmax layer allows for interpreting the outputs as probabilities and selection of classified facie with the highest probability. In particular aspects, a softmax layer may apply a symmetric sigmoid transfer function to each element of the raw outputs independently to interpret the outputs as probabilities in the range of values between −1 and 1. A dropout layer offers a regularization technique for reducing network over-fitting on the training data by dropping out individual nodes with a certain probability. A loss layer (e.g., utilized in training) defines a weight-dependent cost function to be optimized (e.g., bring the cost down toward zero) for improved accuracy. In particular aspects, each hidden layer is a combination of a convolutional layer, a pooling layer, and a ReLU layer in a multilayer architecture. As an example and not by way of limitation, each hidden has a convolutional layer, a pooling layer, and a ReLU layer.

In particular aspects, the deep learning neural network 250 may include an activation function in a ReLU layer (e.g., the hidden layer F 212) to calculate the misfit function based on the difference between the predicted output data 254 and a ground truth. In particular aspects, the deep learning neural network 250 may use a simple data split technique to separate the input data 252 used for the training, validation, and testing of the physics-constrained machine learning models. As example and not by way of limitation, the data split technique may consider 70% of the input data for model training (e.g., tuning of the model parameters), 15% of the obtained input data for validation (e.g., performance validation for each different set of model parameters), and 15% of the obtained input data for testing the final trained model. However, the data split technique may be appropriately adjusted (e.g., by the user) to prevent over-fitting that results in the deep learning neural network 250 with limited generalization capabilities (e.g., models that underperform when predicting unseen sample data).

Furthermore, the deep learning neural network 250 may apply a nested k-fold inner/outer cross-validation to tune and validate the optimal parameters of the model. In one or more aspects, the nested stratified inner/outer cross-validation may be a software and/or hardware system that includes functionality to mitigate the over-fitting problem of the model by applying a k-fold inner cross-validation and a k-fold outer cross-validation. The k-fold inner cross-validation and the k-fold outer cross-validation may have different values of the “k” parameter. In some example aspects, the nested inner/outer cross-validation defines one or more physics constrained machine learning algorithms and their corresponding models in a grid and evaluates one or more performance metrics of interest (e.g., the area under the curve (AUC), accuracy, geometric mean, f1 score, mean absolute error, mean squared error, sensitivity, specificity, etc.) to find the optimal parameters of the neural networks 250.

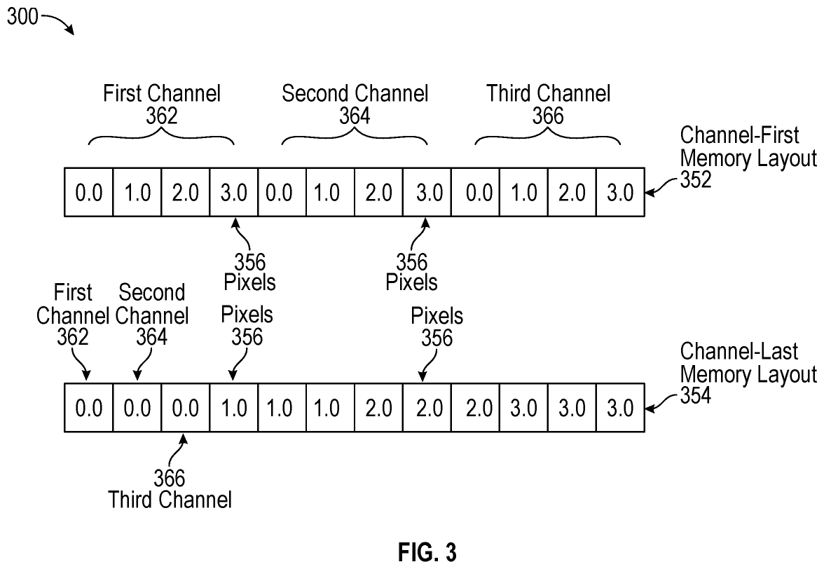

FIG. 3 illustrates an example of a channel-first memory layout 352 and a channel-last memory layout 354 of a model tensor 300 in accordance with aspects of the present disclosure. Memory layout describes data representation of a model tensor which can be characterized by a plurality of pixels 356 in a multidimensional array stored in linear memory address space. The concept of memory format has two aspects: physical order and logical order. Physical order is the layout of data storage in physical memory. Logical order is a convention on how to describe model tensor shape and stride. For example, a 2D model tensor has a shape of three channels (a first channel 362, a second channel 364, and a third channel 366) and four pixels (1.0, 2.0, 3.0, 4.0) in each channel. For a channel-first memory layout 352, the 12 pixels are stored in an order on which channels are stored on the first position of a model tensor 300, such as a first channel 362, a second channel 364, and a third channel 366. For a channel-last memory layout 354, the 12 pixels are stored in an order on which channels are stored on the last position of model tensor 300, such as a first channel 362, a second channel 364, and a third channel 366.

### Example Conversion of a Neural Network From a Source Model Framework to a Target Model Framework

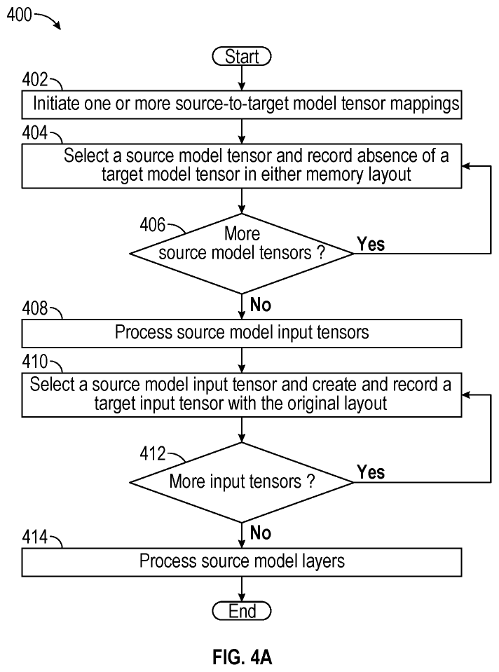

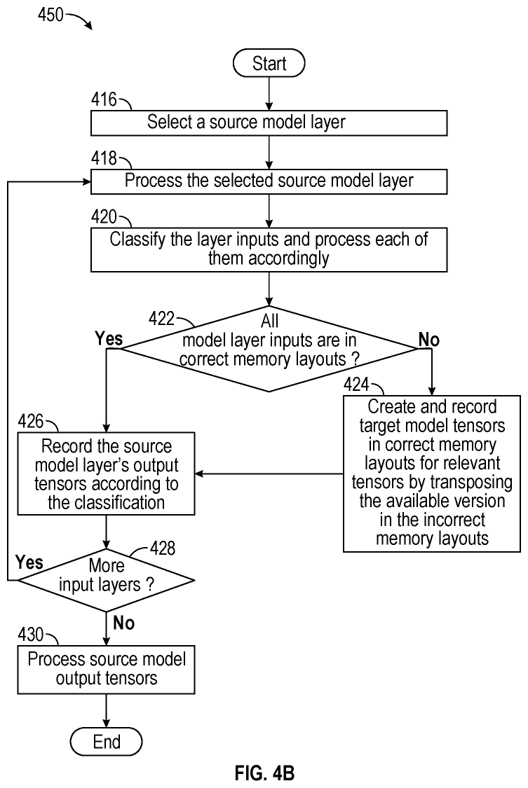

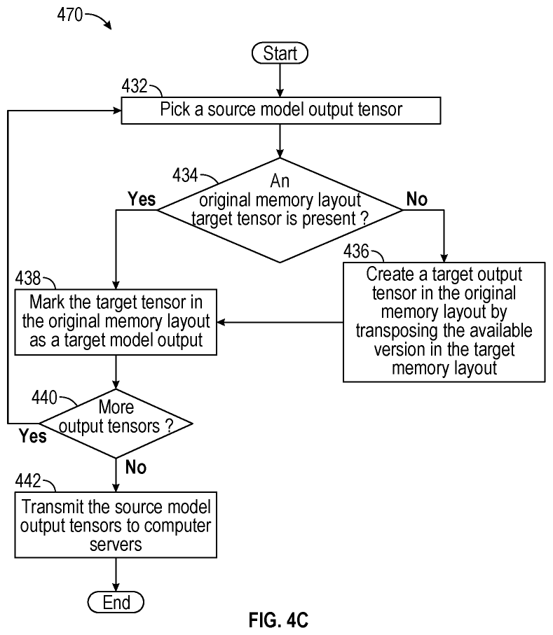

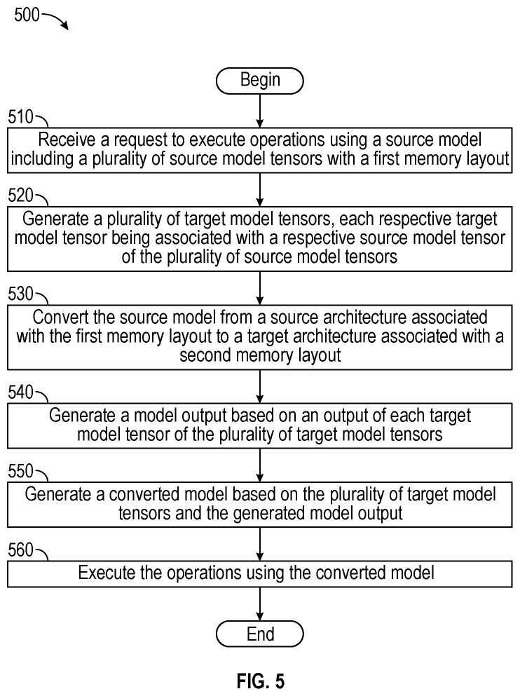

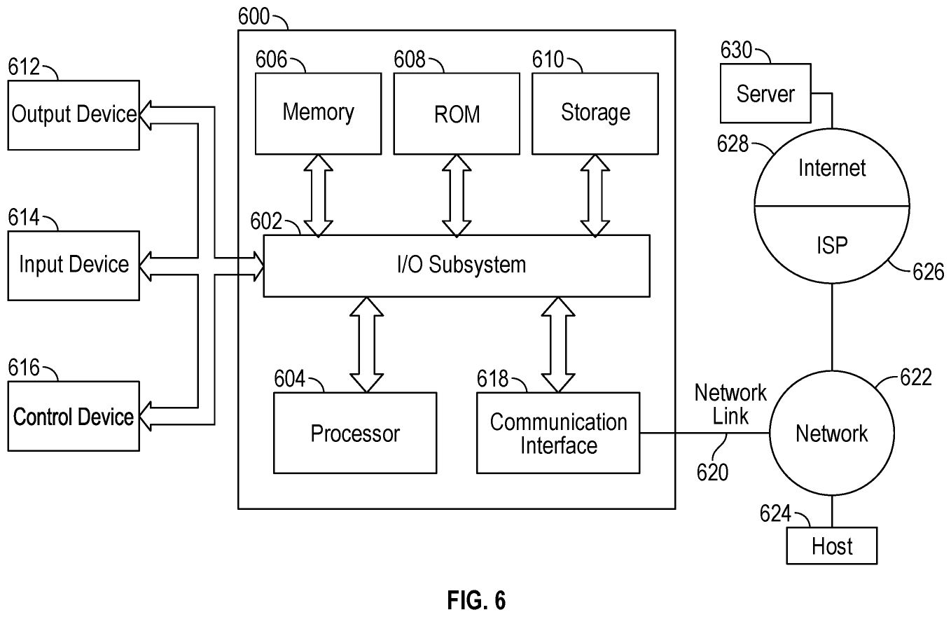

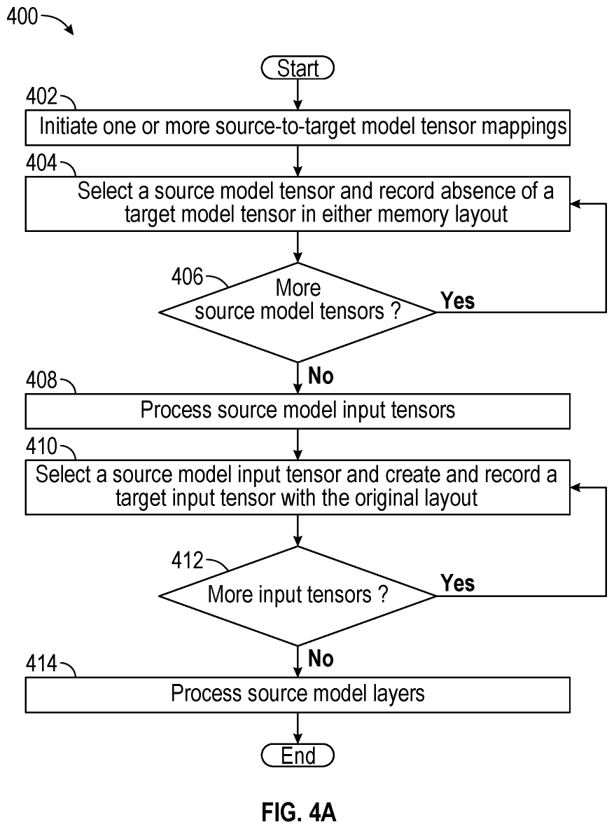

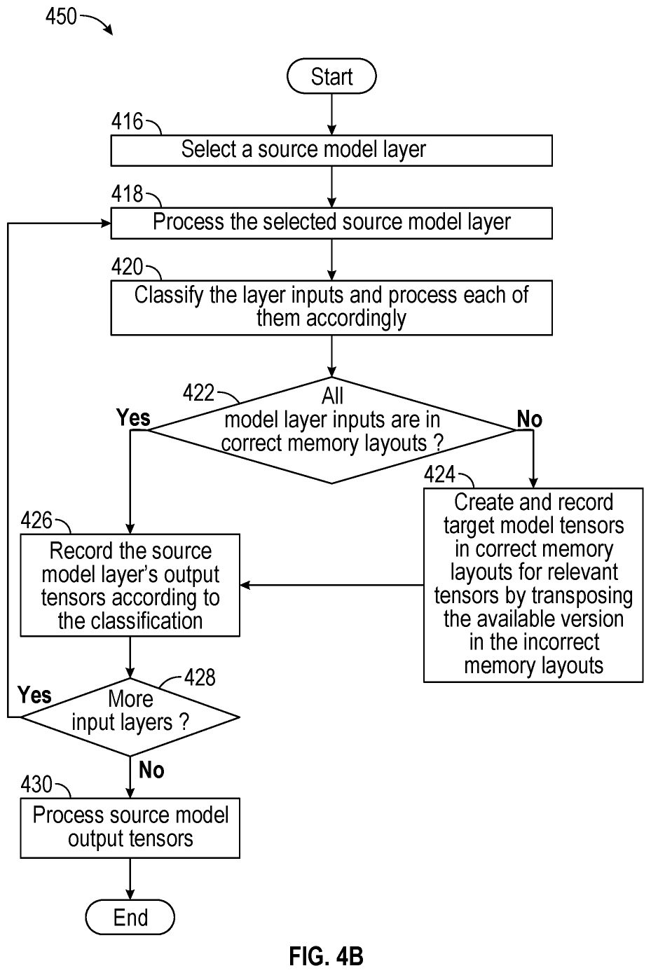

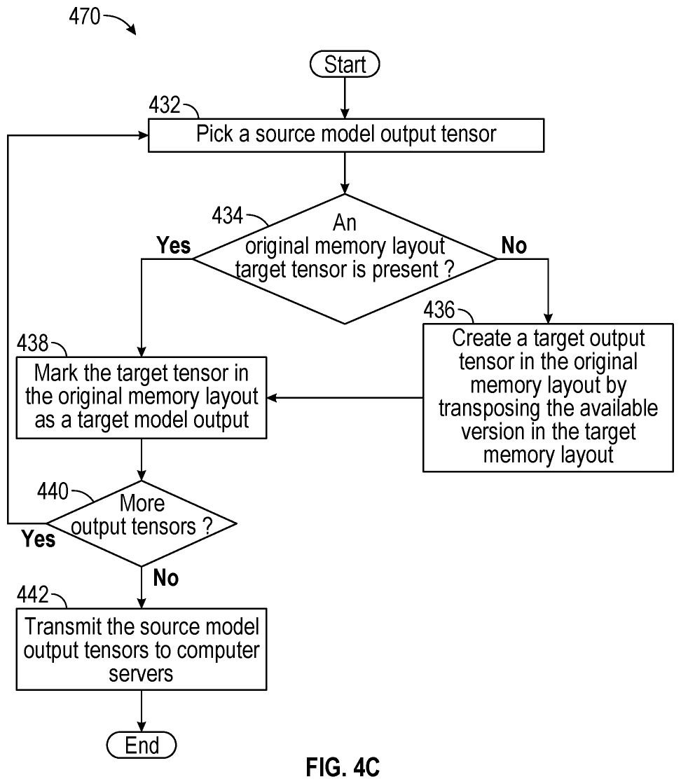

FIG. 4A illustrate an example process 400 for determining initialized maps for a source memory tensor to a target memory layout and target tensors in the source memory layout in accordance with aspects of the present disclosure. One or more blocks in FIG. 4A may be performed by one or more components as described in FIG. 1A, FIG. 1B, FIG. 4A, FIG. 4B, FIG. 4C; for example, the computer server 160 illustrated in FIG. 1A can be programmed, using one or more sequences of instructions, to execute an implementation of FIG. 4A, FIG. 4B, FIG. 4C. While the various blocks in FIG. 4A are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

FIG. 4A and each other flow diagram herein are intended as an illustration of the functional level at which skilled persons, in the art to which this disclosure pertains, communicate with one another to describe and implement a computer-implemented method, as described further herein and/or algorithms using programming. The flow diagrams are not intended to illustrate every instruction, method object, or sub-step that would be needed to program every aspect of a working program but are provided at the same functional level of illustration that is normally used at the high level of skill in this art to communicate the basis of developing working programs.

At block 402, one or more source-to-target tensor mappings are initiated in accordance with one or more aspects. The computer server 160 may determine a list of source model tensors and prepare one or more source-to-target tensor maps for conversion. For example, for each source model tensor, such as an input model tensor associated with an input neural network, the computer server 160 may be configured to prepare a first buffer array to represent the target model tensor in a source memory layout, such as a channel-first memory layout, associated with the source model tensor and a second buffer array to represent the target model tensor in a target memory layout, such as a channel-last memory layout, associated with the target model tensor.

At block 404, a source model tensor is selected and recorded for absence of a corresponding target tensor is either layout in accordance with one or more aspects. The computer server 160 may loop through the list of source model tensors and each time pick a source model tensor from the list of source model tensors using a predetermined order. For example, the list of source model tensors are sorted alphabetically based on one or more properties of the source model tensors. For each selected source model tensor, the computer server 160 may record absence of the corresponding target model tensor in both a channel-first memory layout and a channel-last memory layout.

At block 406, a determination is made whether there is a source model tensor in the list of source model tensors is not recorded in accordance with one or more aspects. Where all source model tensors in the list of source model tensors are recorded, the process may proceed to block 408. Where there is a source model tensor in the list of source model tensors is not recorded, the process may proceed to block 404.

At block 408, one or more source model input tensors are processed in accordance with one or more aspects. In particular, the one or more source model input tensors are associated with the source model for the input neural network.

At block 410, a source model input tensor is selected to create and record a target input tensor with the original layout in accordance with one or more aspects. The computer server 160 may determine one or more source model input tensors associated with the source model. In particular, for each of the one or more source mode input tensors, the computer server 160 may update the first buffer array to store the target model tensor in a source memory layout, such as a channel-first memory layout, associated with the source model tensor.

At block 412, a determination is made whether there is a source model input tensor associated with the source model that is not recorded in accordance with one or more aspects. Where all source model input tensors associated with the source model are recorded, the process may proceed to block 414. Where there is a source model input tensor associated with the source model is not recorded, the process may proceed to block 410.

At block 414, source model layers are processed in accordance with one or more aspects. In particular, the computer server 160 may use the one or more model input tensors to process convert the source model layers from a source memory layout, such as a channel-first memory layout, to a target memory layout, such as a channel-last memory layout.

FIG. 4B illustrates an example process 450 for converting a plurality of model layers of an input neural network from a source memory layout to a target memory layout in accordance with aspects of the present disclosure. One or more blocks in FIG. 4B may be performed by one or more components as described in FIGS. 1A, 1B, and 4A-4C; for example, the computer server 160 can be programmed, using one or more sequences of instructions, to execute an implementation of FIGS. 4A-4C. While the various blocks in FIG. 4B are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

FIG. 4B and each other flow diagram herein are intended as an illustration of the functional level at which skilled persons, in the art to which this disclosure pertains, communicate with one another to describe and implement a computer-implemented method, as described further herein and/or algorithms using programming. The flow diagrams are not intended to illustrate every instruction, method object, or sub-step that would be needed to program every aspect of a working program but are provided at the same functional level of illustration that is normally used at the high level of skill in this art to communicate the basis of developing working programs.

At block 416, a source model layer is selected to process in accordance with one or more aspects. Generally, the source model layer may be selected based on a topological reverse post-order traversal of the source model. In particular, the computer server 160 may determine a plurality of source model layers associated with the source model of the input neural network. For example, the source model may include a convolutional layer, a resize layer, a reshape layer, a grid_sample layer, etc. As another example, the computer server 160 may process the plurality of source model layers by converting one layer at a time.

At block 418, the selected source model layer is processed in accordance with one or more aspects.

At block 420, the layer inputs associated with the selected source model layer are classified and processed in accordance with one or more aspects. For example, the computer server 160 may determine a layer input classification “1” for a reshape layer which may operate on a model layer input in a channel-first memory layout. Thus, the computer server 160 may maintain the source model input tensors associated with the reshape layer in their original layouts. As another example, the computer server 160 may determine a layer input classification “2” for a convolution layer. Thus, the computer server 160 may process the convolution layer from a source input memory layout, such as a channel-first memory layout, to a target memory layout, such as a channel-last memory layout.

At block 422, a determination is made whether all model layer inputs are in correct memory layouts in accordance with one or more aspects. Where all layer inputs are in correct memory layouts, the process may proceed to block 426. Where there is a model layer input not in a correct memory layout, the process may proceed to block 424.

At block 424, target model tensors are created and recorded in correct memory layouts for those needed by transposing the available version in the incorrect memory layout in accordance with one or more aspects. For example, the computer server 160 may create and create a target model tensor in a correct memory layout, such as a channel-last memory layout, when target model tensor is in a wrong memory layout, such as a channel-first memory layout. In particular, the computer server 160 may transpose the target model tensor from the wrong memory layout to the correct memory layout.

At block 426, the source model layer's output tensors are recorded according to the classification in accordance with one or more aspects.

At block 428, a determination is made whether there are more layers in the source model in accordance with one or more aspects, in topological reverse post-order. Where there are more input layers in the source model, the process may proceed to block 418. Where there are no more input layers in the source model, the process may proceed to block 430.

At block 430, the source model output tensors are processed in accordance with one or more aspects. In particular, the computer server 160 may convert the source model output tensors to a target memory layout, such as a channel-last memory layout.

FIG. 4C illustrates an example process 470 for determining an output model tensor in a target memory layout in accordance with aspects of the present disclosure. One or more blocks in FIG. 4C may be performed by one or more components as described in FIGS. 1A, 1B, and 4A-4C; for example, the computer server 160 can be programmed, using one or more sequences of instructions, to execute an implementation of FIGS. 4A-4C. While the various blocks in FIG. 4C are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

FIG. 4C and each other flow diagram herein are intended as an illustration of the functional level at which skilled persons, in the art to which this disclosure pertains, communicate with one another to describe and implement a computer-implemented method, as described further herein and/or algorithms using programming. The flow diagrams are not intended to illustrate every instruction, method object, or sub-step that would be needed to program every aspect of a working program but are provided at the same functional level of illustration that is normally used at the high level of skill in this art to communicate the basis of developing working programs.

At block 432, a source model output tensor is picked to convert to a target memory layout in accordance with one or more aspects. In particular, the computer server 160 may select the source model output tensor from the one or more target tensors in the source model output tensors.

At block 434, a determination is made whether the selected source model output tensor has a version with the original memory layout in accordance with one or more aspects. Where the selected source model output tensor has a version with the original memory layout, the process may proceed to block 438. Where the selected source model output tensor does not have a version with the original memory layout, the process may proceed to block 436.

At block 436, a target output tensor in the original memory layout is created by transposing the selected source model output tensor in the target memory layout in accordance with one or more aspects.

At block 438, the target output tensor in the original memory layout is marked as a target model output in accordance with one or more aspects.

At block 440, a determination is made whether there are more output tensors in accordance with one or more aspects. Where there are more output tensors, the process may proceed to block 432. Where there are no more output tensors, the process may proceed to optional block 442.

At block 442, the source model optionally output tensors are transmitted to computer servers in accordance with one or more aspects. In particular, computer server 160 may transmit the source model output tensors to the computer servers 160 as output data associated with target neural networks 150 based on the input data associated with the input neural network 120.

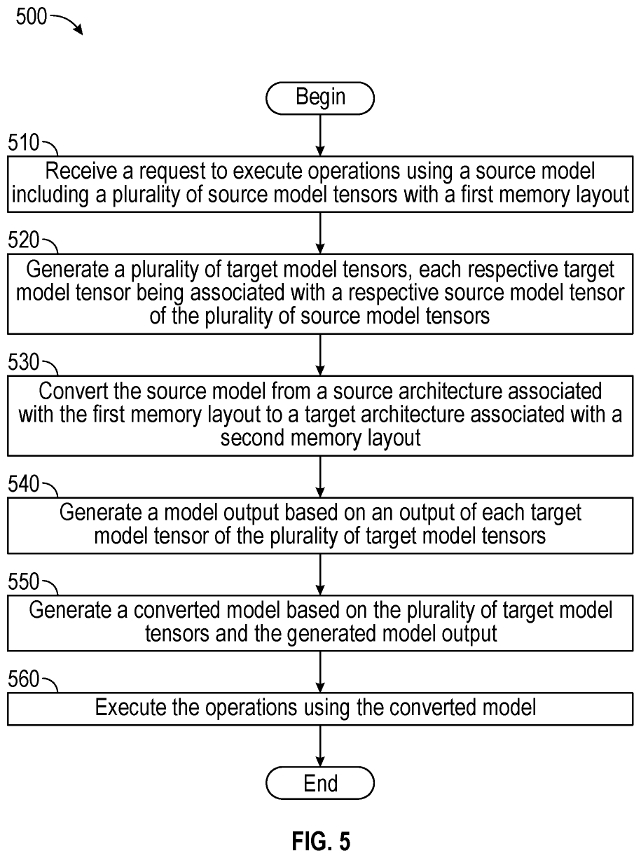

FIG. 5 illustrates example operations 500 for converting a neural network from a source model framework associated with a first memory layout to a target model framework associated with a second memory layout (e.g., as described with respect to FIGS. 1A, 1B, 3, and 4A-4C above), according to aspects of the present disclosure. The operations 500 may be performed, for example, by a computing device on which a neural network or other machine learning model is executed, such as an edge device (e.g., a smartphone, a tablet computer, a laptop computer, a desktop computer, etc.), a server or cluster of servers on which a neural network is deployed, a virtual computing instance, or the like.

As illustrated, the operations 500 begin at block 510 with receiving a request to execute operations using a source model including a plurality of source model tensors with a first memory layout.

At block 520, the operations 500 proceed with generating a plurality of target model tensors, each respective target model tensor being associated with a respective source model tensor of the plurality of source model tensors.

At block 530, the operations 500 proceed with converting the source model from a source architecture associated with the first memory layout to a target architecture associated with a second memory layout. Generally, to do so, the source model may be performed on a per-tensor basis. For each respective target model tensor of the plurality of target model tensors, the respective source model tensor in the first memory layout may be converted to a respective target model tensor in the second memory layout based on a type of a machine learning model layer associated with the respective source model tensor.

In some aspects, converting the source model to the target architecture is based on a traversal of a graph representing the source model. The traversal of the graph may be, for example, a topological reverse post-order traversal of the graph representing the source model. The graph representing the source model may include a plurality of layers. Each layer in the graph may correspond to a layer in the source model, and a root node of the graph corresponds to an input layer of the source model.

In some aspects, converting the respective source model tensor to the respective target model tensor comprises transposing the respective source model tensor from the first memory layout to the second memory layout when the machine learning model layer associated with the respective source model tensor comprises a convolutional layer.

In some aspects, converting the respective source model tensor to the respective target model tensor comprises transposing the respective source model tensor to a defined layout prior to executing a reshaping operation when the machine learning model layer associated with the respective source model tensor comprises one of a reshaping layer or a matrix multiplication layer.

In some aspects, converting the respective source model tensor to the respective target model tensor comprises converting the respective source model tensor to a memory layout compatible with another input into the machine learning model layer when the machine learning model layer associated with the respective source model tensor comprises a binary pointwise operation-based layer.

At block 540, the operations 500 proceed with generating a model output based on an output of each target model tensor of the plurality of target model tensors.

At block 550, the operations 500 proceed with generating a converted model based on the plurality of target model tensors and the generated model output.

At block 560, the operations 500 proceed with executing the operations using the converted model.

In some aspects, the first memory layout comprises a channel-first memory layout and wherein the second memory layout comprises a channel-last memory layout.

### Example Systems for Converting a Neural Network From a Source Model Framework to a Target Model Framework

According to one aspect, the techniques described herein are implemented by at least one computing device. The techniques may be implemented in whole or in part using a combination of at least one server computer and/or other computing devices coupled using a network, such as a packet data network. The computing devices may be hard-wired to perform the techniques or may include digital electronic devices such as at least one application-specific integrated circuit (ASIC) or field programmable gate array (FPGA) that is persistently programmed to perform the techniques or may include at least one general purpose hardware processor programmed to perform the techniques pursuant to program instructions in firmware, memory, other storage, or a combination. To accomplish the described techniques, such computing devices may combine custom hard-wired logic, ASICs, or FPGAs with custom programming. The computing devices may be server computers, workstations, personal computers, portable computer systems, handheld devices, mobile computing devices, wearable devices, body-mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

FIG. 6 is a block diagram that illustrates an example computer system with which an aspect may be implemented. In the example of FIG. 6, a computer system 600 and instructions for implementing the disclosed technologies in hardware, software, or a combination of hardware and software, are represented schematically, for example, as boxes and circles, at the same level of detail that is commonly used by persons of ordinary skill in the art to which this disclosure pertains for communicating about computer architecture and computer systems implementations.

The computer system 600 includes an input/output (I/O) subsystem 602, which may include a bus and/or other communication mechanism(s) for communicating information and/or instructions between the components of the computer system 600 over electronic signal paths. The I/O subsystem 602 may include an I/O controller, a memory controller, and at least one I/O port. The electronic signal paths are represented schematically in the drawings, such as lines, unidirectional arrows, or bidirectional arrows.

At least one hardware processor 604 is coupled to the I/O subsystem 602 for processing information and instructions. The hardware processor 604 may include, for example, a general-purpose microprocessor or microcontroller and/or a special-purpose microprocessor such as an embedded system or a graphics processing unit (GPU), or a digital signal processor or ARM processor. The hardware processor 604 may comprise an integrated arithmetic logic unit (ALU) or be coupled to a separate ALU.

The computer system 600 includes one or more units of the memory 606, such as a main memory, coupled to the I/O subsystem 602 for electronically digitally storing data and instructions to be executed by the hardware processor 604. The memory 606 may include volatile memory such as various forms of random-access memory (RAM) or other dynamic storage device. The memory 606 also may be used for storing temporary variables or other intermediate information during the execution of instructions to be executed by the hardware processor 604. Such instructions, when stored in non-transitory computer-readable storage media accessible to the hardware processor 604, can render the computer system 600 into a special-purpose machine customized to perform the operations specified in the instructions.

The computer system 600 includes non-volatile memory such as a read-only memory (ROM) 608 or other static storage devices coupled to the I/O subsystem 602 for storing information and instructions for the hardware processor 604. The ROM 608 may include various forms of programmable ROM (PROM), such as erasable PROM (EPROM) or electrically erasable PROM (EEPROM). A unit of persistent storage 610 may include various forms of non-volatile RAM (NVRAM), such as FLASH memory, solid-state storage, magnetic disk, or optical disks such as CD-ROM or DVD-ROM and may be coupled to the I/O subsystem 602 for storing information and instructions. The storage 610 is an example of a non-transitory computer-readable medium that may be used to store instructions and data which, when executed by the hardware processor 604, cause performing computer-implemented methods to execute the techniques herein.

The instructions in the memory 606, the ROM 608, or the storage 610 may comprise one or more instructions organized as modules, methods, objects, functions, routines, or calls. The instructions may be organized as one or more computer programs, operating system services, or application programs, including mobile apps. The instructions may comprise an operating system and/or system software; one or more libraries to support multimedia, programming, or other functions; data protocol instructions or stacks to implement TCP/IP, HTTP, or other communication protocols; file format processing instructions to parse or render files coded using HTML, XML, JPEG, MPEG, or Portable Network Graphics (PNG); user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server, or web client. The instructions may be organized as a presentation, application, and data storage layer, such as a relational database system using a structured query language (SQL) or no SQL, an object store, a graph database, a flat file system, or other data storage.

The computer system 600 may be coupled via the I/O subsystem 602 to at least one output device 612. In one aspect, the output device 612 is a digital computer display. Examples of a display that may be used in various aspects include a touchscreen display, a light-emitting diode (LED) display, a liquid crystal display (LCD), or an e-paper display. The computer system 600 may include other type(s) of the output devices 612, alternatively or in addition to a display device. Examples of other the output devices 612 include printers, ticket printers, plotters, projectors, sound cards or video cards, speakers, buzzers or piezoelectric devices or other audible devices, lamps or LED or LCD indicators, haptic devices, actuators or servos.

At least one input device 614 is coupled to the I/O subsystem 602 for communicating signals, data, command selections, or gestures to the hardware processor 604. Examples of input devices 614 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 616, which may perform cursor control or other automated control functions such as navigation in a graphical interface on a display screen, alternatively or in addition to input functions. The control device 616 may be a touchpad, a mouse, a trackball, or cursor direction keys for communicating direction information and command selections to the hardware processor 604 and for controlling cursor movement on an output device 612, such as a display. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism, or other control device. An input device 614 may include a combination of multiple input devices, such as a video camera and a depth sensor.

In another aspect, the computer system 600 may comprise an Internet of Things (IoT) device in which one or more of the output device 612, the input device 614, and the control device 616 are omitted. Or, in such an aspect, the input device 614 may comprise one or more cameras, motion detectors, thermometers, microphones, seismic detectors, other sensors or detectors, measurement devices or encoders, and the output device 612 may comprise a special-purpose display such as a single-line LED or LCD display, one or more indicators, a display panel, a meter, a valve, a solenoid, an actuator or a servo.

When the computer system 600 is a mobile computing device, the input device 614 may comprise a global positioning system (GPS) receiver coupled to a GPS module that is capable of triangulating to a plurality of GPS satellites, determining and generating geo-location or position data such as latitude-longitude values for a geophysical location of the computer system 600. The output device 612 may include hardware, software, firmware, and interfaces for generating position reporting packets, notifications, pulse or heartbeat signals, or other recurring data transmissions that specify a position of the computer system 600, alone or in combination with other application-specific data, directed toward the host computer 624 or the server computer 630.

The computer system 600 may implement the techniques described herein using customized hard-wired logic, at least one ASIC or FPGA, firmware, and/or program instructions or logic which, when loaded and used or executed in combination with the computer system, causes or programs the computer system to operate as a special-purpose machine. According to one aspect, the techniques herein are performed by the computer system 600 in response to the hardware processor 604 executing at least one sequence of at least one instruction contained in the main memory 606. Such instructions may be read into the main memory 606 from another storage medium, such as the storage 610. Execution of the sequences of instructions contained in main memory 606 causes processor 604 to perform the process steps described herein. In alternative aspects, hard-wired circuitry may be used in place of or in combination with software instructions.

The term “storage media,” as used herein, refers to any non-transitory media that store data and/or instructions that cause a machine to operate in a specific fashion. Such storage media may comprise non-volatile media and/or volatile media. Non-volatile media includes, for example, optical or magnetic disks, such as the storage 610. Volatile media includes dynamic memory, such as the memory 606. Common forms of storage media include, for example, a hard disk, solid state drive, flash drive, magnetic data storage medium, any optical or physical data storage medium, memory chip, or the like.

Storage media is distinct but may be used with transmission media. Transmission media participates in transferring information between storage media. For example, transmission media includes coaxial cables, copper wire and fiber optics, and wires comprising a bus of the I/O subsystem 602. Transmission media can also be acoustic or light waves generated during radio-wave and infrared data communications.

Various forms of media may carry at least one sequence of at least one instruction to the hardware processor 604 for execution. For example, the instructions may initially be carried on a remote computer's magnetic disk or solid-state drive. The remote computer can load the instructions into its dynamic memory and send them over a communication link such as a fiber optic, coaxial cable, or telephone line using a modem. A modem or router local to the computer system 600 can receive the data on the communication link and convert the data to a format that can be read by the computer system 600. For instance, a receiver such as a radio frequency antenna or an infrared detector can receive the data carried in a wireless or optical signal and appropriate circuitry can provide the data to the I/O subsystem 602 such as place the data on a bus. The I/O subsystem 602 carries the data to the memory 606, from which the hardware processor 604 retrieves and executes the instructions. The instructions received from the memory 606 may optionally be stored on the storage 610 either before or after execution by the hardware processor 604.

The computer system 600 also includes a communication interface 618 coupled to a bus or the I/O subsystem 602. The communication interface 618 provides a two-way data communication coupling to a network link(s) 620 directly or indirectly connected to at least one communication network, such as a network 622 or a public or private cloud on the Internet. For example, the communication interface 618 may be an Ethernet networking interface, integrated-services digital network (ISDN) card, cable modem, satellite modem, or a modem to provide a data communication connection to a corresponding type of communications line, for example, an Ethernet cable or a metal cable of any kind or a fiber-optic line or a telephone line. The network 622 broadly represents a local area network (LAN), wide-area network (WAN), campus network, internetwork, or any combination thereof. The communication interface 618 may comprise a LAN card to provide a data communication connection to a compatible LAN, a cellular radiotelephone interface that is wired to send or receive cellular data according to cellular radiotelephone wireless networking standards, or a satellite radio interface that is wired to send or receive digital data according to satellite wireless networking standards. In any such implementation, the communication interface 618 sends and receives electrical, electromagnetic, or optical signals over signal paths that carry digital data streams representing various types of information.

The network link 620 typically provides electrical, electromagnetic, or optical data communication directly or through at least one network to other data devices, using, for example, satellite, cellular, Wi-Fi, or BLUETOOTH technology. For example, the network link 620 may connect through the network 622 to a host computer 624.

Furthermore, the network link 620 may connect through the network 622 or to other computing devices via internetworking devices and/or computers operated by an Internet Service Provider (ISP) 626. The ISP 626 provides data communication services through a worldwide packet data communication network called the Internet 628. A server computer 630 may be coupled to the Internet 628. The server computer 630 broadly represents any computer, data center, virtual machine, or virtual computing instance with or without a hypervisor, or computer executing a containerized program system such as DOCKER or KUBERNETES. The server computer 630 may represent an electronic digital service that is implemented using more than one computer or instance and that is accessed and used by transmitting web services requests, uniform resource locator (URL) strings with parameters in HTTP payloads, application programming interface (API) calls, app services calls, or other service calls. The computer system 600 and the server computer 630 may form elements of a distributed computing system that includes other computers, a processing cluster, a server farm, or other organizations of computers that cooperate to perform tasks or execute applications or services. The server computer 630 may comprise one or more instructions organized as modules, methods, objects, functions, routines, or calls. The instructions may be organized as one or more computer programs, operating system services, or application programs, including mobile apps. The instructions may comprise an operating system and/or system software; one or more libraries to support multimedia, programming, or other functions; data protocol instructions or stacks to implement TCP/IP, HTTP, or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The server computer 630 may comprise a web application server that hosts a presentation layer, application layer, and data storage layer, such as a relational database system using a structured query language (SQL) or no SQL, an object store, a graph database, a flat file system or other data storage.

The computer system 600 can send messages and receive data and instructions, including program code, through the network(s), the network link 620, and the communication interface 618. In the Internet example, the server computer 630 might transmit a requested code for an application program through the Internet 628, the ISP 626, the network 622, and the communication interface 618. The received code may be executed by the hardware processor 604 as it is received and/or stored in the storage 610 or other non-volatile storage for later execution.

The execution of instructions, as described in this section, may implement a process in the form of an instance of a computer program that is being executed and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share the hardware processor 604. While each the hardware processor 604 or core of the processor executes a single task at a time, the computer system 600 may be programmed to implement multitasking to allow each processor to switch between tasks that are being executed without having to wait for each task to finish. In an aspect, switches may be performed when tasks perform input/output operations when a task indicates that it can be switched or on hardware interrupts. Time-sharing may be implemented to allow fast response for interactive user applications by rapidly performing context switches to provide the appearance of concurrent execution of multiple processes. In an aspect, for security and reliability, an operating system may prevent direct communication between independent processes, providing strictly mediated and controlled inter-process communication functionality.

### Example Clauses

Clause 1: A processor-implemented method for machine learning model conversion, comprising: receiving a request to execute operations using a source model including a plurality of source model tensors with a first memory layout; generating a plurality of target model tensors, each respective target model tensor being associated with a respective source model tensor of the plurality of source model tensors; converting the source model from a source architecture associated with the first memory layout to a target architecture associated with a second memory layout, wherein converting the source model comprises, for each respective target model tensor of the plurality of target model tensors, converting the respective source model tensor in the first memory layout to a respective target model tensor in the second memory layout based on a type of a machine learning model layer associated with the respective source model tensor; generating a model output based on an output of each target model tensor of the plurality of target model tensors; generating a converted model based on the plurality of target model tensors and the generated model output; and executing the operations using the converted model.

Clause 2: The method of Clause 1, wherein converting the source model to the target architecture is based on a traversal of a graph representing the source model.

Clause 3: The method of Clause 2, wherein the traversal of the graph representing the source model comprises a topological reverse post-order traversal of the graph representing the source model.

Clause 4: The method of Clause 2 or 3, wherein the graph representing the source model comprises a plurality of layers, each layer in the graph corresponding to a layer in the source model, and wherein a root node of the graph corresponds to an input layer of the source model.

Clause 5: The method of any of Clauses 1 through 4, wherein the first memory layout comprises a channel-first memory layout and wherein the second memory layout comprises a channel-last memory layout.

Clause 6: The method of any of Clauses 1 through 5, wherein converting the respective source model tensor to the respective target model tensor comprises transposing the respective source model tensor from the first memory layout to the second memory layout when the machine learning model layer associated with the respective source model tensor comprises a convolutional layer.

Clause 7: The method of any of Clauses 1 through 6, wherein converting the respective source model tensor to the respective target model tensor comprises transposing the respective source model tensor to a defined layout prior to executing a reshaping operation when the machine learning model layer associated with the respective source model tensor comprises one of a reshaping layer or a matrix multiplication layer.

Clause 8: The method of Clauses 1 through 7, wherein converting the respective source model tensor to the respective target model tensor comprises converting the respective source model tensor to a memory layout compatible with another input into the machine learning model layer when the machine learning model layer associated with the respective source model tensor comprises a binary pointwise operation-based layer.

Clause 9: A processing system, comprising: at least one memory having executable instructions stored thereon; and one or more processors configured to execute the executable instructions to cause the processing system to perform the operations of any of Clauses 1 through 8.

Clause 10: A processing system, comprising means for performing the operations of any of Clauses 1 through 8.

Clause 11: A non-transitory computer-readable medium having executable instructions stored thereon which, when executed by one or more processors, performs the operations of any of Clauses 1 through 8.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system for machine learning model conversion, comprising:
at least one memory having executable instructions stored thereon; and
one or more processors configured to execute the executable instructions in order to cause the processing system to:
receive a request to execute operations using a source model including a plurality of source model tensors with a first memory layout;
generate a plurality of target model tensors, each respective target model tensor being associated with a respective source model tensor of the plurality of source model tensors;
convert the source model from a source architecture associated with the first memory layout to a target architecture associated with a second memory layout, wherein converting the source model comprises, for each respective target model tensor of the plurality of target model tensors, converting the respective source model tensor in the first memory layout to a respective target model tensor in the second memory layout based on a type of a machine learning model layer associated with the respective source model tensor;
generate a model output based on an output of each target model tensor of the plurality of target model tensors;
generate a converted model based on the plurality of target model tensors and the generated model output; and
execute the operations using the converted model.

2. The processing system of claim 1, wherein the one or more processors are configured to cause the processing system to convert the source model to the target architecture is based on a traversal of a graph representing the source model.

3. The processing system of claim 2, wherein the traversal of the graph representing the source model comprises a topological reverse post-order traversal of the graph representing the source model.

4. The processing system of claim 2, wherein the graph representing the source model comprises a plurality of layers, each layer in the graph corresponding to a layer in the source model, and wherein a root node of the graph corresponds to an input layer of the source model.

5. The processing system of claim 1, wherein the first memory layout comprises a channel-first memory layout and wherein the second memory layout comprises a channel-last memory layout.

6. The processing system of claim 1, wherein to convert the respective source model tensor to the respective target model tensor, the one or more processors are configured to cause the processing system to transpose the respective source model tensor from the first memory layout to the second memory layout when the machine learning model layer associated with the respective source model tensor comprises a convolutional layer.

7. The processing system of claim 1, wherein convert the respective source model tensor to the respective target model tensor, the one or more processors are configured to cause the processing system to transpose the respective source model tensor to a defined layout prior to executing a reshaping operation when the machine learning model layer associated with the respective source model tensor comprises one of a reshaping layer or a matrix multiplication layer.

8. The processing system of claim 1, wherein convert the respective source model tensor to the respective target model tensor, the one or more processors are configured to cause the processing system to convert the respective source model tensor to a memory layout compatible with another input into the machine learning model layer when the machine learning model layer associated with the respective source model tensor comprises a binary pointwise operation-based layer.

9. A processor-implemented method for machine learning model conversion, comprising:
receiving a request to execute operations using a source model including a plurality of source model tensors with a first memory layout;
generating a plurality of target model tensors, each respective target model tensor being associated with a respective source model tensor of the plurality of source model tensors;
converting the source model from a source architecture associated with the first memory layout to a target architecture associated with a second memory layout, wherein converting the source model comprises, for each respective target model tensor of the plurality of target model tensors, converting the respective source model tensor in the first memory layout to a respective target model tensor in the second memory layout based on a type of a machine learning model layer associated with the respective source model tensor;
generating a model output based on an output of each target model tensor of the plurality of target model tensors;
generating a converted model based on the plurality of target model tensors and the generated model output; and
executing the operations using the converted model.

10. The method of claim 9, wherein converting the source model to the target architecture is based on a traversal of a graph representing the source model.

11. The method of claim 10, wherein the traversal of the graph representing the source model comprises a topological reverse post-order traversal of the graph representing the source model.

12. The method of claim 10, wherein the graph representing the source model comprises a plurality of layers, each layer in the graph corresponding to a layer in the source model, and wherein a root node of the graph corresponds to an input layer of the source model.

13. The method of claim 9, wherein the first memory layout comprises a channel-first memory layout and wherein the second memory layout comprises a channel-last memory layout.

14. The method of claim 9, wherein converting the respective source model tensor to the respective target model tensor comprises transposing the respective source model tensor from the first memory layout to the second memory layout when the machine learning model layer associated with the respective source model tensor comprises a convolutional layer.

15. The method of claim 9, wherein converting the respective source model tensor to the respective target model tensor comprises transposing the respective source model tensor to a defined layout prior to executing a reshaping operation when the machine learning model layer associated with the respective source model tensor comprises one of a reshaping layer or a matrix multiplication layer.

16. The method of claim 9, wherein converting the respective source model tensor to the respective target model tensor comprises converting the respective source model tensor to a memory layout compatible with another input into the machine learning model layer when the machine learning model layer associated with the respective source model tensor comprises a binary pointwise operation-based layer.

17. A non-transitory computer-readable medium having instructions stored thereon which, when executed by one or more processors, performs an operation for machine learning model conversion, the operation comprising:
receiving a request to execute operations using a source model including a plurality of source model tensors with a first memory layout;
generating a plurality of target model tensors, each respective target model tensor being associated with a respective source model tensor of the plurality of source model tensors;
converting the source model from a source architecture associated with the first memory layout to a target architecture associated with a second memory layout, wherein converting the source model comprises, for each respective target model tensor of the plurality of target model tensors, converting the respective source model tensor in the first memory layout to a respective target model tensor in the second memory layout based on a type of a machine learning model layer associated with the respective source model tensor;
generating a model output based on an output of each target model tensor of the plurality of target model tensors;
generating a converted model based on the plurality of target model tensors and the generated model output; and
executing the operations using the converted model.

18. The computer-readable medium of claim 17, wherein converting the source model to the target architecture is based on a traversal of a graph representing the source model.

19. The computer-readable medium of claim 18, wherein:
the traversal of the graph representing the source model comprises a topological reverse post-order traversal of the graph representing the source model,
the graph representing the source model comprises a plurality of layers, each layer in the graph corresponding to a layer in the source model, and
a root node of the graph corresponds to an input layer of the source model.

20. The computer-readable medium of claim 17, wherein the first memory layout comprises a channel-first memory layout and wherein the second memory layout comprises a channel-last memory layout.
